(19) United States
(12) Patent Application Publication
(10) Pub. No.: US 2026/0361520 A1
(43) Pub. Date: Nov. 12, 2026

(54) METHODS AND APPARATUS FOR QUANTUM-SAFE SUBSCRIPTION IDENTIFIER PROTECTION

(71) Applicant: InterDigital Patent Holdings, Inc., Wilmington, DE (US)

(72) Inventors: Chonggang WANG, Princeton, NJ (US); Samir Ferdi, Kirkland (CA); Yi Zhang, San Jose, CA (US); Alec Brusilovsky, Downingtown, PA (US); Zhibi Wang, Woodbridge, IL (US); Robert Gazda, Spring City, PA (US)

(73) Assignee: InterDigital Patent Holdings, Inc., Wilmington, PA (US)

(21) Appl. No.: 19/202,736

(22) Filed: May 8, 2025

(51) Int. Cl. H04L 9/08

(52) U.S. Cl. CPC H04L 9/0852

(57) ABSTRACT

Devices and methods are disclosed for performing a post-quantum cryptography (PQC)-based subscription identifier protection (SID). In one example, a WTRU may receive subscription permanent identifier (SUPI) privacy protection schemes (SUPIPPSs) from a home network. The WTRU may select a PQC-based SUPIPPS and may use the selected SUPIPPS to encrypt its SUPI to generate a subscription concealed identifier (SUCI). A PQC Signature or a message authentication code (MAC)-Tag may be generated with respect to the SUCI. The WTRU may send the SUCI, the PQC Signature, or the MAC-Tag, and the identifier/name of the selected PQC-based SUPIPPS to the network. Additional embodiments are disclosed.

### BACKGROUND

The security threats posed by quantum computer technology to next generation network (also called herein 6GS) are a concern. In the current 5G era, both symmetric and asymmetric cryptography are used widely in 5GS. The subscription permanent identifier (SUPI) privacy protection scheme in 5GS is based on Elliptic Curve Integrated Encryption Scheme (ECIES), which uses both symmetric and asymmetric cryptography. Quantum computers are foreseen to bring about severe security threats affecting asymmetric cryptographic algorithms. Therefore, existing ECIES-based SUPI privacy protection schemes (referred to as non-PQC-based SUPI privacy protection schemes) are expected to be vulnerable to quantum attacks. Future SUPI privacy protection schemes for 6GS will need to be quantum-safe or quantum-resistant.

One key issue is how to integrate Post-Quantum Cryptography (PQC) algorithms (e.g., PQC Key Encapsulation Method (KEM) algorithms and/or PQC digital signature algorithms (DSA)) into 3GPP systems to protect SUPI privacy efficiently (e.g., achieving a reasonable balance between resulting communication overhead and computation overhead). Another key issue is how to support both PQC enabled user equipment (UE) and non PQC enabled UE in transitioning from today's 3GPP systems to quantum-safe systems of the next generation networks.

### SUMMARY

In a first aspect, mechanisms are disclosed for a UE, also referred to herein as a wireless transmit/receive unit (WTRU), to leverage a Post-Quantum Cryptography Key Encapsulation Method (PQC-KEM) algorithm to take a WTRU subscription permanent identifier (SUPI) as an input message and a public key of the home network as the encapsulation key to encrypt the SUPI and generate a subscription concealed identifier (SUCI). The WTRU may also leverage a PQC-digital signature algorithm (DSA) to generate a digital signature to protect the integrity of the SUCI. A private key used by the PQC-DSA algorithm to generate the digital signature may be derived from the shared secret key that the PQC-KEM algorithm encapsulates. In an alternative aspect, a Message Authentication Code (MAC) algorithm may be used to generate a MAC-Tag using the same shared secret key, without using a PQC-DSA algorithm.

According to additional aspects, mechanisms are disclosed for the WTRU to leverage a non-PQC-based Subscription Identifier (SID) encryption algorithm and a PQC-based SID encryption algorithm sequentially. A SUPI may be encrypted sequentially twice by the non-PQC-based SID encryption algorithm and the PQC-based SID encryption algorithm, respectively, to generate a final SUCI. Then, the final SUCI may be taken as the input to generate a digital signature and/or a MAC-Tag to protect the integrity of the final SUCI.

In a further aspect, mechanisms are disclosed for a home network (e.g., unified data management (UDM) to configure one or more SUPI Privacy Protection Schemes (SUPIPPSs) or SUPI protection profile for a WTRU. The WTRU may select a SUPIPPS from a configuration (or network provided list) of SUPIPPSs. The WTRU may transform or conceal or encrypt WTRU's a partial SUPI (e.g., a subscription identifier part of a SUPI) to generate a SUCI according to the selected SUPIPPS (e.g., using either a PQC-based or a non-PQC-based algorithm). The WTRU may send the SUCI to the home network, which may recover or de-conceal or decrypt the SUCI to the corresponding SUPI of the WTRU. The home network may re-configure new SUPIPPS to the WTRU, for example, when the capability of supporting SUPIPPSs at the home network and/or as the WTRU evolves and changes. Additional aspects, features and/or advantages may become apparent from the detailed embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a network message diagram illustrating an example overall procedure of transitioning from Non-post quantum cryptography (PQC) subscription permanent identifier (SUPI) privacy protection scheme (SUPIPPS) to PQC-based SUPIPPS;

FIG. 3 is a network message diagram illustrating an example method of SUPIPPS negotiation and selection during registration according to an embodiment;

FIG. 4 is an architecture flow diagram illustrating a method of subscription identifier protection using separate PQC key encapsulation method (KEM) and PQC digital signature algorithm (DSA) according to an example embodiment;

FIG. 5 is an architecture flow diagram illustrating a method of subscription identifier protection using integrated PQC KEM and PQC DSA from a WTRU-side perspective according to an example embodiment;

FIG. 6 is an architecture flow diagram illustrating a method of subscription identifier protection using integrated PQC KEM and PQC DSA from a network-side perspective according to an example embodiment;

FIG. 7 is an architecture flow diagram illustrating a method of subscription identifier protection from a WTRU perspective using only PQC KEM according to an example embodiment;

FIG. 8 is a block flow diagram illustrating a method of subscription identifier protection from a home network perspective using only PQC KEM according to an example embodiment;

FIG. 9 is a block flow diagram illustrating a method of cascaded subscription identifier encryption with a signature and/or message authentication code (MAC)-tag from a WTRU-side perspective according to an example embodiment;

FIG. 10 is a block flow diagram illustrating a method of cascaded subscription identifier encryption with a signature and/or MAC-tag from a home network-side perspective according to an example embodiment;

FIG. 11 is a block flow diagram illustrating a method for WTRU-side cascaded subscription identifier encryption with independent non-PQC MAC-tag and PQC signature/MAC-tag;

FIG. 12 is a block flow diagram illustrating a method for home network-side cascaded subscription identifier encryption with independent non-PQC MAC-tag and PQC signature/MAC-tag;

FIG. 13 is a flow diagram illustrating a method for a WTRU performing a PQC-based subscription identifier protection according to an example embodiment; and

FIG. 14 is a flow diagram illustrating a method for a WTRU performing a hybrid subscription identifier protection based on PQC and non-PQC algorithms according to an example embodiment.

### DETAILED DESCRIPTION

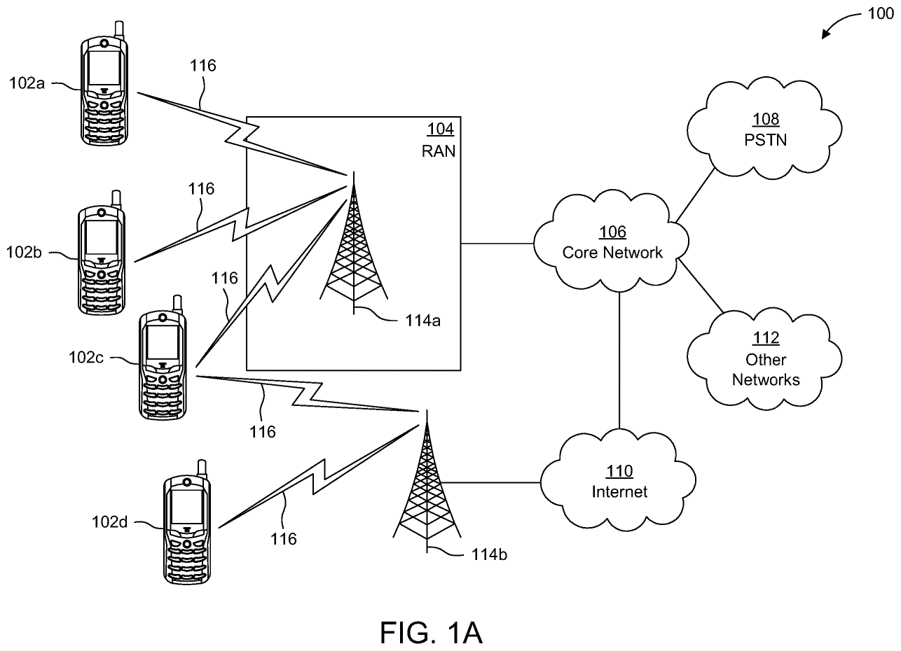

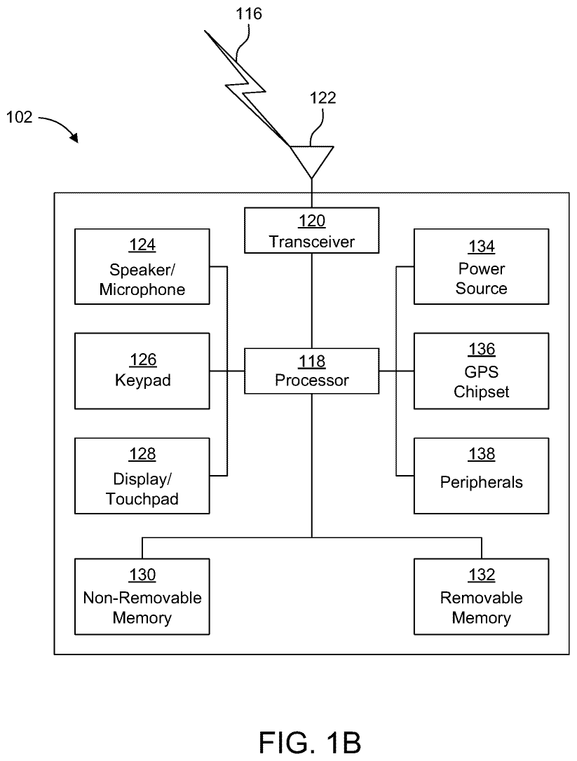

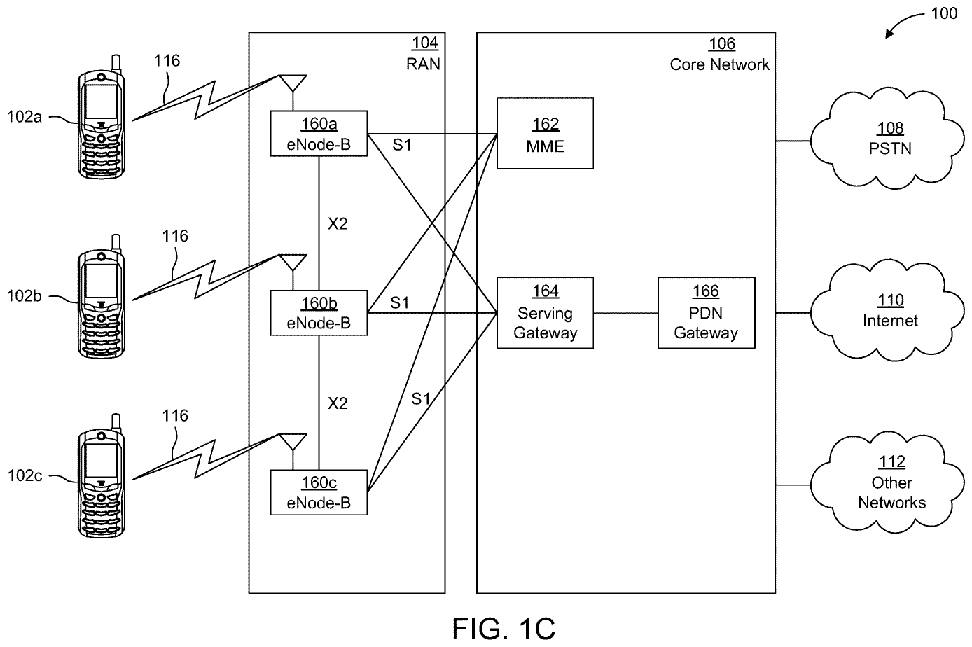

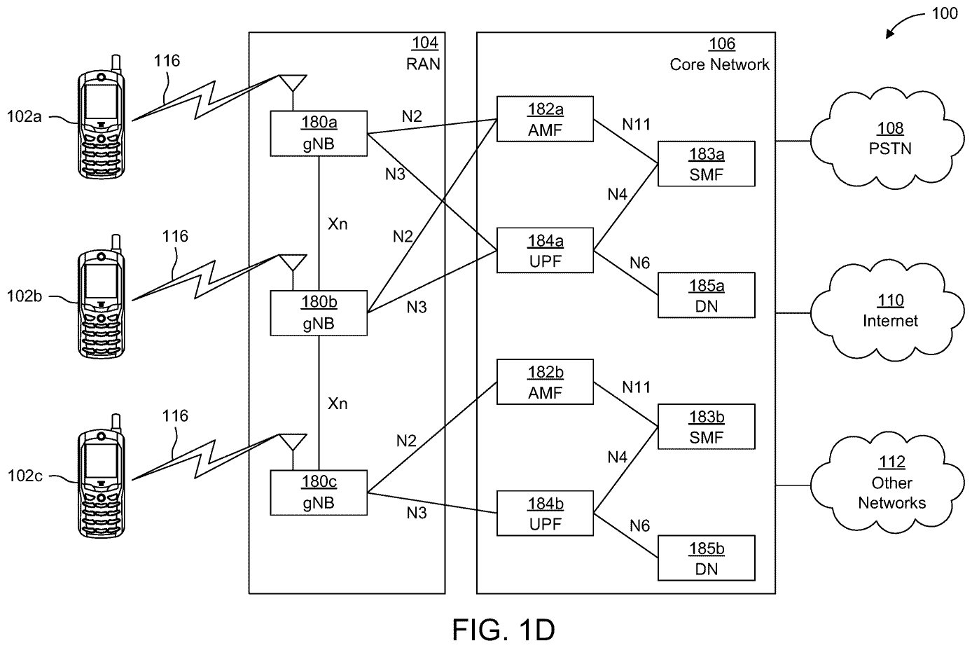

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Post-Quantum Cryptography (PQC) relates to cryptography able to maintain privacy in the wake of quantum computing. Quantum computing is set to change the dynamics of computing within the next decade. One major concern of post-Quantum attack is the perfect forward secrecy attack by storing encrypted data now and decrypting it later using a quantum computer, referred to as “store-now-decrypt-later” or “harvest-now-decrypt-later” attack. Quantum computers threaten cryptography that relies on certain computational complexity mainly through two powerful algorithms as of today: Shor's algorithm and Grover's search.

Shor's algorithm can efficiently solve the problems of large integer factorization and discrete logarithms, making asymmetric key cryptographies, such as RSA (Rivest, Shamir and Adleman) public-key encryption and/or elliptical curve cryptography (ECC), highly vulnerable. On the other hand, Grover's search algorithm can speed up the search process, potentially impacting symmetric cryptography. However, it is currently considered infeasible even with mid-term quantum computers.

Asymmetric key cryptography, that relies on the computational complexity of large integer factorization and discrete logarithms, is much more vulnerable than symmetric key cryptography. According to expert estimates from the Global Risk Institute, there is a very high probability that within the next 25 to 30 years, quantum computers will be able to break RSA encryption with a 2048-bit key in just 24 hours.

Quantum-Safe Cryptography (QSC) is intended to protect the information exchange between individual users or data sources using algorithms that are resistant to attacks by both classical and quantum computers and keep this information secure even with the development of a mature quantum computing capability. The National Institute of Standards and Technology (NIST) initiated the process of the Post-Quantum Cryptography (PQC) standardization in 2017. As part of this initiative, NIST has announced the standard candidates of five post-quantum cryptographic algorithms, respectively, for public-key encryption (CRYSTALS-Kyber and HQC) and digital signature (CRYSTALS-Dilithium, SPHINCS+ and FALCON). These algorithms are developed to resist against attacks leveraging quantum computing.

Module-Lattice-based key encapsulation mechanism (ML-KEM): also known as CRYSTALS-Kyber, a lattice-based key encapsulation mechanism (KEM) designed for secure key exchange (Federal Information Processing Standards (FIPS) 203, approved in 2022).

Hamming Quasi-Cyclic (HQC): Recently selected by NIST, HQC is a code-based key encapsulation mechanism that offers a stronger robustness than ML-KEM but with longer ciphertext (approved in 2025).

Module-Lattice-based digital signature algorithm (ML-DSA): also known as CRYSTALS-Dilithium, is a lattice-based digital signature algorithm providing strong security and efficiency (FIPS 204, approved in 2022)

Stateless Hash-Based Digital Signature Algorithm (SLH-DSA): also known as SPHINCS+, is a stateless hash-based digital signature scheme which takes the advantages of avoiding dependence only on the security of lattices for signatures (FIPS 205, approved in 2022)

Fast-Fourier transform over NTRU-Lattice-Based Digital Signature Algorithm (FN-DSA): also known as FALCON, is a lattice-based digital signature algorithm which takes the advantages of shorter public key size and signatures compared with other digital signature algorithms (FIPS 206, to be approved)

Table 1 below compares the security levels of some conventional cryptographic algorithms and PQC algorithms. Generally, the higher security levels, the longer the key size and the longer the ciphertext/signature.

TABLE 1
Comparison of Security Levels

| Security | AES/SHA (2/3) | |
|---|---|---|
| Level | Hardness | PQC Algorithms |
| 1 | AES-128 | ML-KEM-512, FN-DSA-512, |
| | | SLH-DSA-SHA2/SHAKE-128f/s |
| 2 | SHA-256/ | ML-DSA-44 |
| | SHA3-256 | |
| 3 | AES-192 | ML-KEM-768, ML-DSA-65, |
| | | SLH-DSA-SHA2/SHAKE-192f/s |
| 4 | SHA-384/ | No algorithm tested at this level |
| | SHA3-384 | |
| 5 | AES-256 | ML-KEM-1024, ML-DSA-87, |
| | | FN-DSA-1024, SLH-DSA-SHA2/ |
| | | SHAKE-256f/s |

SUPI Privacy Protection in 5GS. As defined in 3GPP TS 33.501, 5G security functions include the following ECIES-based SUbscription Permanent Identifier (SUPI) protection scheme:

Subscription Concealed Identifier (SUCI) is introduced as an encrypted version of SUPI. The UE/WTRU generates a SUCI using a protection scheme (e.g., ECIES-based) with a scheme input, which consists of the public key of the home network, the subscription identifier part of the SUPI. ECIES is based on the hybrid use of asymmetric and symmetric cryptography. The SUCI instead of SUPI is transmitted over the air (from the WTRU to the serving network) to protect the SUPI privacy in 5G non-access stratum (NAS) messages such as: Initial Registration Request, Identity Response, and De-Registration Request.

A subscription identifier de-concealing function (SIDF) at the home network uses the private key of the home network to de-conceal the SUPI from a received SUCI. The SIDF is a logical entity within the Unified Data Management (UDM).

As mentioned previously, quantum attacks to 3GPP systems is a concern. The security threats posed by Quantum technology to next generation network (also called herein 6GS) are a focus being evaluated. In the current 5G era, both symmetric and asymmetric cryptography are used widely in 5GS.

For example, symmetric cryptography is used for primary authentication and the protection of NAS and Access Stratum (AS) and User Plane (UP) on the air interface using 128-bit symmetric key algorithms. Now 3GPP system architecture 3 (SA3) is enhancing cryptographic strength, particularly focusing on symmetric 256-bit algorithms to bolster security to NIST security level 5.

Meanwhile, asymmetric cryptography (e.g., public key cryptography) is also used in various security domains, including network domain security and service-based architecture domain security, such as SUPI protection, transport layer security (TLS)-based service-based interfaces, OAuth, TLS-based N2 and N4 interfaces, IPSec-based N3 interface, etc.

In the 6G era, 3GPP SA3 is planning to start the introduction of PQC algorithms in 3GPP protocol specifications.

Recently, the Alliance for Telecommunications Industry Solutions (ATIS) made two recommendations for migrating 3GPP systems (e.g., 5GS) to be a future quantum-safe system (e.g., 6GS) with PQC protection across devices/WTRU, radio access network, core network, and interconnect network: (1) addressing Harvest Now Decrypt Later (HNDL) attach vulnerabilities, while focusing on enhancing encryption methods; and (2) expanding quantum-safe cryptography to critical communication paths, focusing on protecting the signature and authentication mechanisms across the 5G domains.

As previously mentioned, the SUPI privacy protection scheme in 5GS is based on ECIES, which uses both symmetric and asymmetric cryptography. Quantum computers are foreseen to bring about severe security threats affecting asymmetric cryptographic algorithms. Therefore, existing ECIES-based SUPI protection schemes (referred to as non-PQC-based SUPI protection schemes) are expected to be vulnerable to quantum attacks. Future SUPI privacy protection schemes for 6GS will need to be quantum-safe or quantum-resistant.

The following related two key issues need to be addressed:
(1) To make SUPI protection quantum-safe, PQC algorithms may be leveraged to replace the existing ECIES-based non-PQC SUPI protection scheme. Although PQC algorithms provide quantum-safe key encapsulation mechanisms and quantum-safe digital signature mechanisms, they do not directly translate to the solution of quantum-safe SUPI protection. In addition, a PQC algorithm usually has longer ciphertext/signature/security keys than a non-PQC algorithm, which may introduce higher communication overhead as well as higher computation overhead. A key issue is how to integrate PQC algorithms (e.g., PQC KEM algorithms and/or PQC DSA algorithms) into 3GPP systems to protect SUPI privacy efficiently (e.g., achieving a good balance between resulting communication overhead and computation overhead).
(2) Non-PQC-based SUPI protection schemes and PQC-based SUPI protection schemes may co-exist in future wireless systems, especially during the transition phase of migrating today's 3GPP system to quantum-safe systems. For example, some UEs (e.g., legacy UEs) may still only support non-PQC-based SUPI protection schemes, while other UEs may support PQC-based SUPI protection schemes. It is also possible that a UE may support both non-PQC-based and PQC-based SUPI protection scheme. A key issue is how to support both PQC enabled UEs and non PQC enabled UEs.

Embodiments are disclosed herein where the system (also called herein 6GS) enables quantum-safe SUPI privacy protection or more general quantum-safe subscription identifier privacy protection.

For example, embodiments are disclosed for the home network (e.g., UDM) to configure one or more SUPI Privacy Protection Schemes (SUPIPPSs) or SUPI protection profile to a WTRU. The WTRU may select a SUPIPPS from the configured SUPIPPSs. The WTRU may transform or conceal or encrypt WTRU's SUPI (e.g., MSIN, the subscription identifier part of a SUPI) to generate a SUCI according to the selected SUPIPPS (either PQC-based or Non-PQC-based). The WTRU may send the SUCI to the home network, which may recover or de-conceal or decrypt the SUCI to the corresponding SUPI. The home network may re-configure new SUPIPPS to the WTRU, for example, when the capability of supporting SUPIPPSs at the home network and/or at the WTRU evolves and changes (addressing the key issue #2 above).

Other embodiments are disclosed for the WTRU to leverage a PQC-KEM algorithm to take a SUPI as the input message and the public key of the home network as the encapsulation key to encrypt the SUPI and generate a SUCI. The WTRU may also leverage a PQC-DSA algorithm to generate a digital signature to protect the integrity of the SUCI; the private key used by the PQC-DSA algorithm to generate the digital signature may be derived from the shared secret key that the PQC-KEM algorithm encapsulates. Alternatively, a Message Authentication Code (MAC) algorithm may be used to generate an MAC-Tag using the same shared secret, without using a PQC-DSA algorithm (addressing the key issue #1 above).

Additional embodiments are disclosed for the WTRU to leverage a Non-PQC-based SID encryption algorithm and a PQC-based SID encryption algorithm sequentially. A SUPI may be encrypted sequentially twice by the Non-PQC-based SID encryption algorithm and the PQC-based SID encryption algorithm, respectively, to generate a final SUCI. Then, the final SUCI may be taken as the input to generate a digital signature and/or an MAC-Tag to protect the integrity of the SUCI (addressing the key issue #1 above).

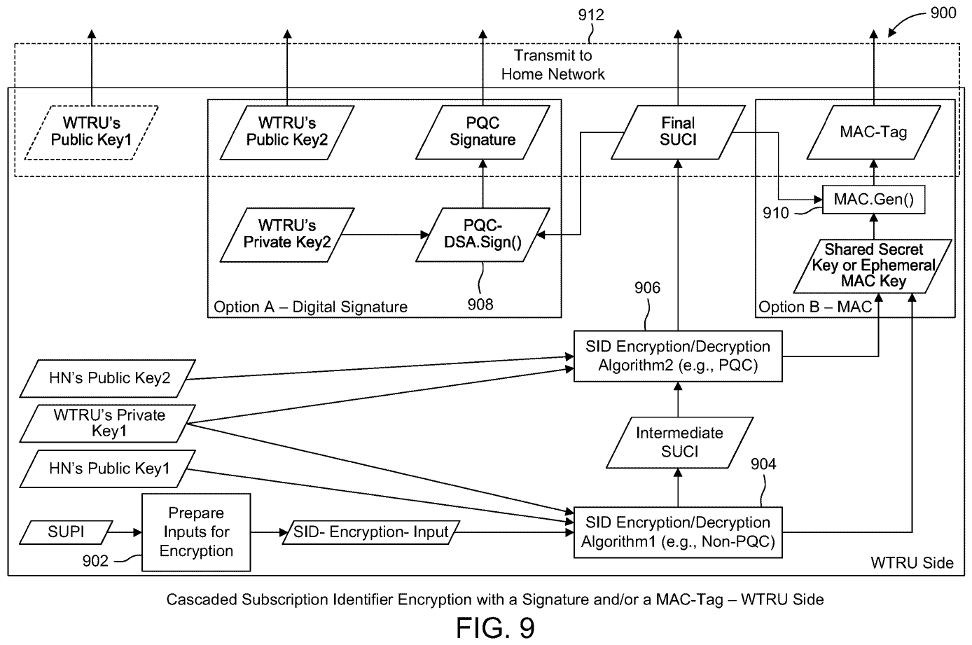

Some terms used in the disclosed embodiments are described as follows:
SUPI Privacy Protection Scheme (SUPIPPS): A scheme or an approach, or a method that protects a SUPI when it is transmitted from a WTRU to a home network. The protection may include but is not limited to privacy protection, integrity protection, etc. A SUPIPPS may be Non-PQC-based (e.g., ECIES in 5GS) or PQC-based. A SUPIPPS may be a hybrid SUPIPPS that includes a Non-PQC-based SUPI and a PQC-based SUPI (e.g., FIG. 9-FIG. 12). SUPIPPS and SUPI protection profile may be used interchangeably in disclosed embodiments. A SUPIPPS may include needed operations at the WTRU side and/or reciprocal operations at the home network side.

In certain embodiments, operation at the WTRU side using a SUPIPPS may include: 1) encrypt a SUPI to a SUCI; 2) sign the SUCI to generate a signature (and/or an authentication/MAC tag); and 3) transmit the SUCI, the signature (and/or an authentication/MAC tag), other public key materials and the used SUPIPPS to the home network.

In certain embodiments, operation at the home network side may include: 1) receive the SUCI, the signature (and/or an authentication/MAC tag), other public key materials and the used SUPIPPS from the WTRU; 2) verify signature (and/or an authentication/MAC tag); and 3) decrypt the SUCI to the SUPI.

SUPI Privacy Protection Capability (SUPIPPC): A list of supported SUPIPPSs at the WTRU, and/or at the home network.

SUCI: Subscription Concealed Identifier is the same as in 5GS. In the following embodiments, a SUCI may be generated using existing ECIES in 5GS and may be referred to as Non-PQC-based SUCI or traditional SUCI. A SUCI being generated using PQC-based schemes may be referred to as PQC-based SUCI.

A Partial SUCI: A part of a SUCI (e.g., routing indicator).

Intermediate SUCI: In hybrid SUPIPPS embodiments, two SUPIPPSs or two SID encryption algorithms are employed sequentially. The encrypted version of a SUPI as the output of the first SUPIPPS or the first SID encryption algorithm is referred to as Intermediate SUCI.

Final SUCI: In hybrid SUPIPPS embodiments, two SUPIPPSs or two SID encryption algorithms are employed sequentially. The encrypted version of the Intermediate SUCI, as the output of the second SUPIPPS or the second SID encryption algorithm is referred to as Final SUCI.

WTRU and UE may be interchangeably used the disclosed embodiments.

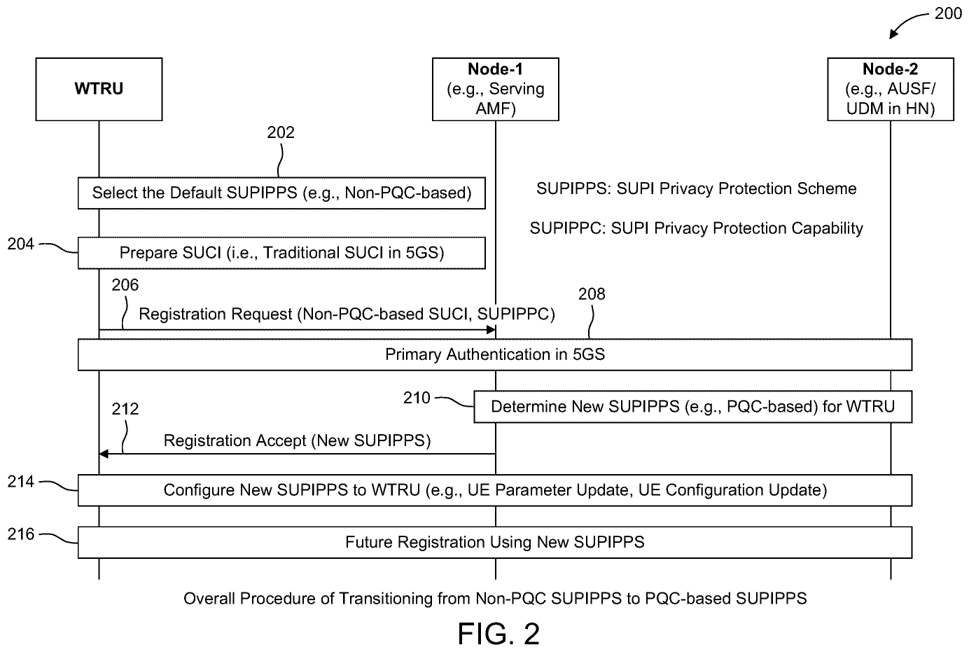

Referring to FIG. 2, a method 200 is shown for transitioning from non-PQC-based SUPI Privacy Protection Scheme (SUPIPPS) to PQC-based SUPIPPS. The entities shown in FIG. 2 include a WTRU, a Node-1 and a Node-2. In an example, Node-1 may be a serving access and mobility management function (AMF) in a serving network, while Node-2 may be network functions such as an authentication server function (AUSF) and/or unified data management (UDM) in the home network. With this procedure, Node-2 and Node-1 are able to instruct the WTRU to transition or migrate from a non-PQC-based SUPIPPS to a PQC-based SUPIPPS or a hybrid SUPIPPS.

Some prerequisites for FIG. 2 method 200 may include: (i) the WTRU has obtained its SUPI; (ii) the WTRU has obtained its SUPIPPC (e.g., a list of SUPIPPSs that the WTRU supports); (iii) the WTRU will use a radio access network (RAN) to contact Node-1; and (iv) Node-2 has maintained the SUPI of the WTRU.

FIG. 2 method 200 may include, at 202, the WTRU may select a non-PQC-based SUPIPPS (i.e., ECIES-based scheme in 5GS) as the default SUPIPPS, although the WTRU may support PQC-based SUPIPPSs, it may not know if the home network supports PQC-based SUPIPPSs.

At 204, the WTRU may prepare a SUCI according to the non-PQC-based SUPIPPS. At 206, the WTRU may send an initial registration request to Node-1. This request may contain the non-PQC-based SUCI generated in 204 and other parameters as defined in the 5GS for a registration request, the context information of the WTRU (e.g., software and hardware info of the WTRU), and the security requirement of the WTRU (e.g., required security level), and SUPIPPC. In an example, the SUPIPPC may be a list of identifiers/names of supported SUPIPPSs.

At 208, the existing 5G primary authentication may be performed across the WTRU, Node-1, and Node-2. At 210, if the 5G primary authentication is successful, Node-2 may select and determine one or more new SUPIPPSs for the WTRU, for example, considering the radio network information (e.g., radio network type, radio network availability, and trust indicator), SUPIPPC of the WTRU, the context information of the WTRU, and/or the security requirement of the WTRU that Node-1 may send to Node-2. In an example, Node-2 may send new SUPIPPSs to Node-1.

In some examples, 210 may be a part of 208. In this case, Node-1 may pass its radio network information (e.g., radio network type, radio network availability, and trust indicator), SUPIPPC of the WTRU, the context information of the WTRU, and the security requirement of the WTRU to Node-2 as a part of primary authentication. At 212, Node-1 may send a Registration Accept message to the WTRU. Besides parameters defined in 5GS for a Registration Accept message, this message may also contain the new SUPIPPS as determined in 210. In one example, the selected new SUPIPPSs for the WTRU may be stored at Node-1 and/or Node-2. In some embodiments, each new SUPIPPS may contain one or a combination of the following SUPIPPS parameters (1)-(7):
(1) SUPIPPS-ID: The name and/or identifier of the SUPIPPS (e.g., “PQC-KEM”, “PQC-KEM & PQC-DSA”, “PQC-KEM & Non-PQC”, “Hybrid PQC-based/Non-PQC-based SUPIPPS” etc.).
(2) SUPIPPS-Security-Level: The security level that the SUPIPPS can achieve (e.g., security levels as described in Table 1 above).
(3) SUPIPPS-Encryption-Algorithm: The encryption algorithm that the SUPIPPS uses to encrypt/conceal a SUPI, such as ML-KEM-512, ML-KEM-768, ML-KEM-1024.
(4) SUPIPPS-Integrity-Algorithm: The Integrity algorithm that the SUPIPPS uses to protect a generated SUCI (either based on digital signature or MAC-tag), such as ML-DSA-44, ML-DSA-65, ML-DSA-87.
(5) SUPIPPS-Input-Parameters: A list of input parameters that the SUPIPPS requires in order to generate a SUCI and corresponding digital signature/MAC-Tag.
(6) SUPIPPS-Output-Parameters: A list of output parameters that the SUPIPPS generates and/or that need to be sent from the WTRU to Node-2, such as, a SUCI, a corresponding digital signature and/or a MAC-Tag, etc.
(7) SUPIPPS-Conditions: The conditions for choosing the SUPIPPS. Example conditions may be related to the context information of the WTRU and/or the home network (e.g., the location of the WTRU, the radio access network type, a time window, etc.)

After successful registration at 212, at 214, Node-2 may (re-)configure new SUPIPPS to the WTRU using the procedure such as a WTRU parameter update, WTRU configuration update, etc.

In one example, based on the location of the WTRU, the type of radio access network that the WTRU connects to Node-1, and context information (e.g., location, speed, time of day, weather), Node-2 may derive that Node-1 should use a safer SUPIPPSs with a higher security level. In another example, if the radio access network that the WTRU is currently attached to belongs to the home network, Node-2 may derive that Node-1 can use a SUPIPPS with a lower security level. At 216, for future registration, the WTRU will use the newly configured SUPIPPSs to generate the SUCI.

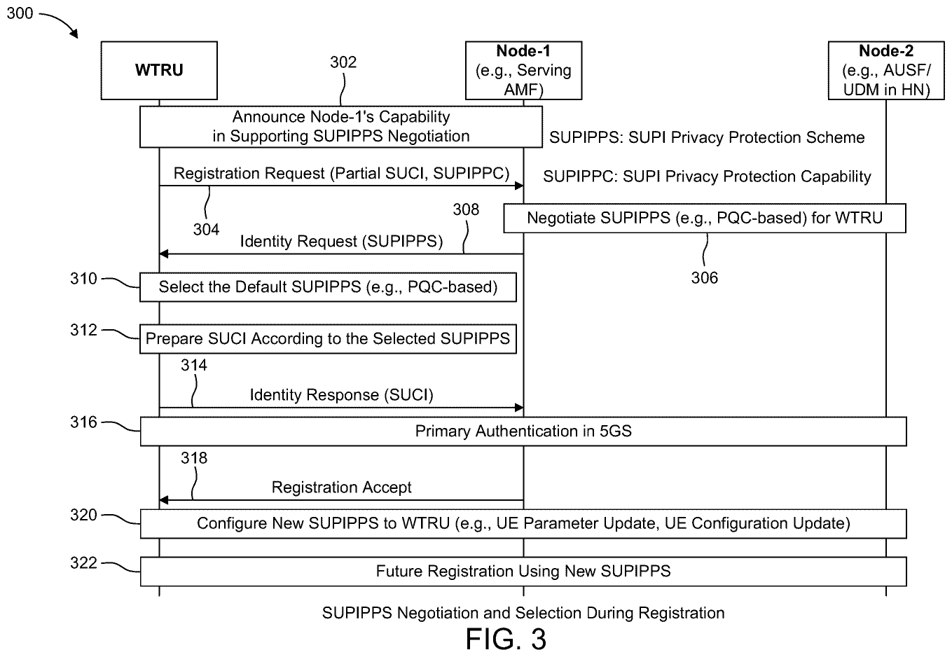

Referring to FIG. 3, a method 300 for negotiating and/or selecting appropriate SUPIPPSs for a WTRU during registration, if the SUPIPPS used at the WTRU and the home network may be different or may be out of sync, is shown according to an example embodiment. Entities involved in FIG. 3 method 300 may be the same as those in FIG. 2 or different. Some prerequisites for FIG. 3 method 300 may include the WTRU: (i) has obtained its SUPI; (ii) has obtained its SUPI Privacy Protection Capability (SUPIPPC) (e.g., a list of SUPIPPSs that the WTRU supports); and (iii) discovers and will use a radio access network to contact Node-1.

FIG. 3, method 300 may include, optionally, at 302, Node-1's capability in supporting SUPIPPS negotiation may be announced through the radio access network that the WTRU attaches (e.g., using 3GPP System Information Blocks (SIB) broadcast messages). In an example, this announcement may indicate or imply that Node-1 may accept a registration requests containing a partial SUCI (e.g., 304)

At 304, the WTRU may send a registration request to Node-1. While the WTRU knows its SUPIPPC, the WTRU may not know which SUPIPPS that the home network may currently support. The WTRU also may not want to transmit non-PQC-based SUCI since it is vulnerable to quantum attacks. Instead, the WTRU may just send a partial SUCI (e.g., routing indicator part of a SUCI) to Node-1 via this registration request, without disclosing the scheme output (i.e., the protected mobile subscriber identification number (MSIN)), especially if the WTRU knows (e.g., via the SIB from 302) that Node-1 may support or assist SUPIPPS negotiation. In an example, this registration request may also contain a SUPIPPC, the context information of the WTRU, and the security requirement of the WTRU, similar to FIG. 2 206.

Node-1 receives the registration request from 304 and in 306, may use the partial SUCI (e.g., routing indicator) to identify Node 2 (e.g., the AUSF/UDM in the home network). Then, Node-1 may send the partial SUCI, SUPIPPC, the radio access network info (e.g., its type, its availability, its trust, etc.), the context information of the WTRU, and the security requirement of the WTRU to Node-2 in negotiating a SUPIPPS for the WTRU. Node-2 may determine one or multiple new SUPIPPS for the WTRU in the negotiation 306, considering the radio network information (e.g., radio network type, radio network availability, and trust indicator), SUPIPPC of the WTRU, the context information of the WTRU, and/or the security requirement of the WTRU. The new SUPIPPS should be supported by both the WTRU and the home network. Node-2 may send the determined new SUPIPPSs to Node-1. Each new SUPIPPS may contain similar SUPIPPS parameters as described in FIG. 2 212.

At 308, Node-1 may send an identity request to the WTRU. This request may contain new SUPIPPS including their SUPIPPS parameters received from Node-2. The WTRU may receive new SUPIPPSs from 308 and at 310, the WTRU may select one new SUPIPPS, for example, according to SUPIPPS-Conditions, SUPIPPS-Security-Level, etc.

At 312, the WTRU may generate a SUCI according to the selected SUPIPPS and at 314, the WTRU may send an identity response to Node-1. This response may contain the SUCI generated in 312 and the selected SUPIPPS. 316 is similar to FIG. 2 208 and the primary authentication will be based on the SUCI included in 312. The registration accept at 318 is similar to FIG. 2 212. The configuration of new SUPIPPS to the WTRU (e.g., via UE parameter update, or UE configuration update) at 320 is similar to FIG. 2 214 and future registration using new SUPIPPS at 322 is similar to FIG. 2 216.

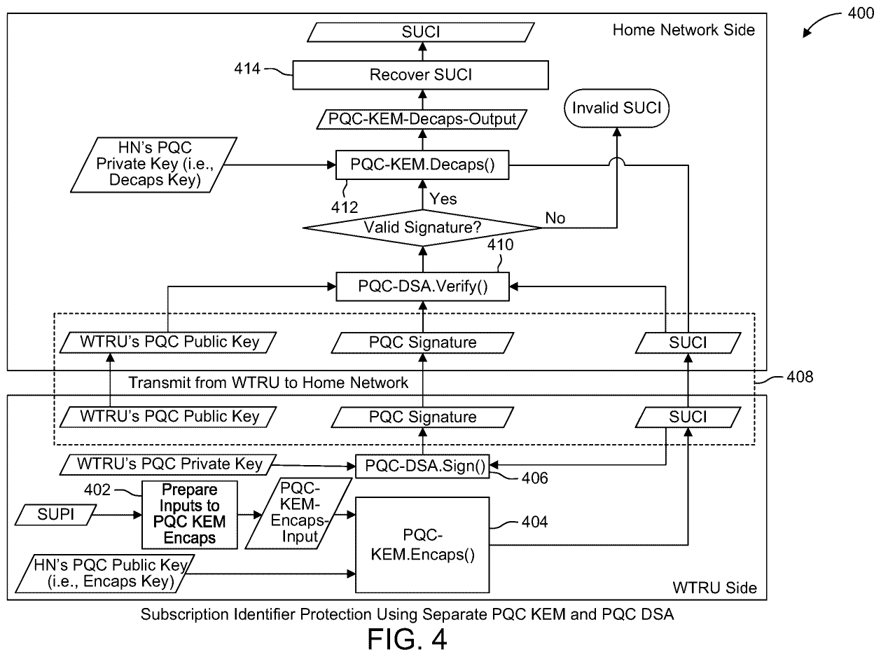

Referring to FIG. 4, a method 400 supporting subscription identifier protection using a PQC KEM algorithm and a PQC DSA algorithm is shown according to an example embodiment. This embodiment may provide a quantum-safe, secure and authorized way of transmitting a WTRU's SUPI from the WTRU to the home network (e.g., home network in 3GPP).

In this embodiment, at the WTRU side, the PQC KEM algorithm may be used to encrypt the WTRU's SUPI (e.g., the MSIN part of a SUPI) and generate a SUCI (or a ciphertext). The PQC DSA algorithm may be used to sign the SUCI to generate a PQC Signature. At the home network side, the PQC DSA algorithm may be used to verify the PQC Signature and the PQC KEM algorithm may be used to decrypt the SUCI to recover the SUPI of the WTRU.

Some prerequisites for FIG. 4 method 400 may include: (i) the WTRU has obtained its SUPI; (ii) the WTRU has generated a pair of <WTRU's PQC Public Key, WTRU's PQC Private Key>, which may have a larger size than that in classical asymmetric cryptography; (iii) the WTRU has obtained or has been configured with a PQC public key of the home network (e.g., HN's PQC Public Key), which may have a larger size than the public key in classical asymmetric cryptography; and (iv) the home network has maintained a PQC private key of the home network (e.g., HN's PQC Private Key), which may have a larger size than the private key in classical asymmetric cryptography.

The FIG. 4 method 400 may include, at 402, the WTRU may prepare inputs to PQC KEM encapsulation function PQC-KEM.Encaps( ) Essentially, the WTRU generates a PQC-KEM-Encaps-Input, which may be a concatenation of a SUPI (e.g., the MSIN part of SUPI), context info (e.g., a Registration-Count), and some padding bytes so that the size of the PQC-KEM-Encaps-Input meets the requirements of the PQC-KEM.Encaps( ) function on the input message. Using ML-KEM.Encaps( ) as standardized by NIST in FIPS 203 as an example, the PQC-KEM-Encaps-Input should be 32 bytes.

In one example, the Registration-Count is an integer number that indicates or records the number of successful registrations of the WTRU to the home network. The same Registration Count may separately be maintained at both the WTRU and the home network. The home network may initialize the Registration Count to a default value (e.g., zero) and provision it to the WTRU. After each successful registration, both the WTRU and the home network may increase the Registration Count by one. The home network may reset or re-initialize the Registration Count during or after registration; then, the home network may send the reset value to the WTRU (e.g., via a registration accept message, via a UE parameter update message, via a UE configuration update message). As an alternative example to the Registration-Count, a nonce or a timestamp may be used by the WTRU as an additional input information to PQC-KEM.Encaps( ).

At 404, the WTRU may feed the PQC-KEM-Encaps-Input to PQC-KEM.Encaps( ) (e.g., ML-KEM.Encaps( ) in FIPS 203), which will encrypt the PQC-KEM-Encaps-Input (e.g., using HN's PQC Public Key as the encapsulation key) and the PQC-KEM.Encaps( ) at 404 will output a SUCI (or a Ciphertext). In an example using ML-KEM.Encaps( ) the size of the SUCI may be 768 bytes (in ML-KEM-512), 1088 bytes (in ML-KEM-768), or 1568 bytes (in ML-KEM-1024).

At 406, the WTRU may perform a PQC-DSA.Sign( ) function to generate a quantum-safe signature using a PQC DSA algorithm (e.g., ML-DSA). The PQC-DSA.Sign( ) takes the SUCI and WTRU's PQC Private Key as inputs and the PQC-DSA.Sign( ) of 406 may output a PQC Signature.

In one example, the PQC-DSA.Sign( ) function of 406 is an ML-DSA.Sign( ) as specified in FIPS 204. Using the ML-DSA.Sign( ) as an example, the size of the PQC Signature may be 2420 bytes (in ML-DSA-44), 3309 bytes (in ML-DSA-65), or 4627 bytes (in ML-DSA-87). Using ML-DSA.Sign( ) as an example, the size of the WTRU's PQC Private Key may be 2560 bytes (in ML-DSA-44), 4032 bytes (in ML-DSA-65), or 4896 bytes (in ML-DSA-87).

At 408, the WTRU may send the following information (1)-(4) to the home network:
(1) The WTRU's PQC Public Key: The PQC public key of the WTRU that will be used by PQC-DSA.Verify( ) in 5 to verify the PQC Signature. Using ML-DSA.Sign( ) as an example, the size of the WTRU's PQC Public Key may be 1312 bytes (in ML-DSA-44), 1952 bytes (in ML-DSA-65), or 2592 bytes (in ML-DSA-87).
(2) PQC Signature: The signature generated in 406.
(3) SUCI: The protected subscription identifier or the ciphertext generated in 404.
(4) Identifier of Used SUPIPPS: The identifier or the name of the SUPIPPS that was used to generate the SUCI (e.g., “ML-KEM-512 & ML-DSA-44”.)

The home network may receive the information from the WTRU in 408 (e.g., the WTRU's PQC Public Key, the PQC Signature, the SUCI, the identifier of used SUPIPPS), which will be used as inputs to PQC-DSA.Verify( ) at 410. At 410, the home network may perform the PQC-DSA.Verify( ) function to verify the received PQC Signature as a part of a PQC DSA algorithm (e.g., ML-DSA), which may be determined by the used SUPIPPS. In an example, the output of PQC-DSA.Verify( ) at 410 may be a Boolean value, which indicates if the PQC Signature is valid with respect to the SUCI and the WTRU's PQC Public Key. If the received PQC Signature is verified as an invalid one, an error message “Invalid SUCI or Invalid PQC Signature” may be generated. In an example, this error message may be maintained by the home network and/or be sent to the WTRU. In one example, the PQC-DSA.Verify( ) function of 410 is a ML-DSA.Verify( ) as specified in FIPS 204.

If the PQC Signature is valid, the home network may perform a PQC-KEM.Decaps( ) function at 412 to decrypt the received SUCI. The PQC-KEM.Decaps( ) function of 412 may take HN's PQC Private Key (as a decapsulation key) and the received SUCI as inputs and the output of PQC-KEM.Decaps( ) function of 412, referred to as the PQC-KEM-Decaps-Output, should be same as PQC-KEM-Encaps-Input. In one example, the PQC-KEM.Decaps( ) function of 412 is an ML-KEM.Decaps( ) as specified in FIPS 203.

At 414, the home network may remove context info and any padding bytes from the “PQC-KEM-Decaps-Output” to recover the WTRU's SUPI. In one example, at 414, if the PQC-KEM-Decaps-Output includes some context info (e.g., Registration-Count), the home network may compare the included Registration-Count with the Registration-Count maintained at the home network. If both are equal, the recovered SUPI will be accepted; otherwise, the recovered SUPI may be regarded as an invalid one. In one example, the FIG. 4 method 400 steps 410 and 412 may be swapped (e.g., the home network may perform 412 before 410).

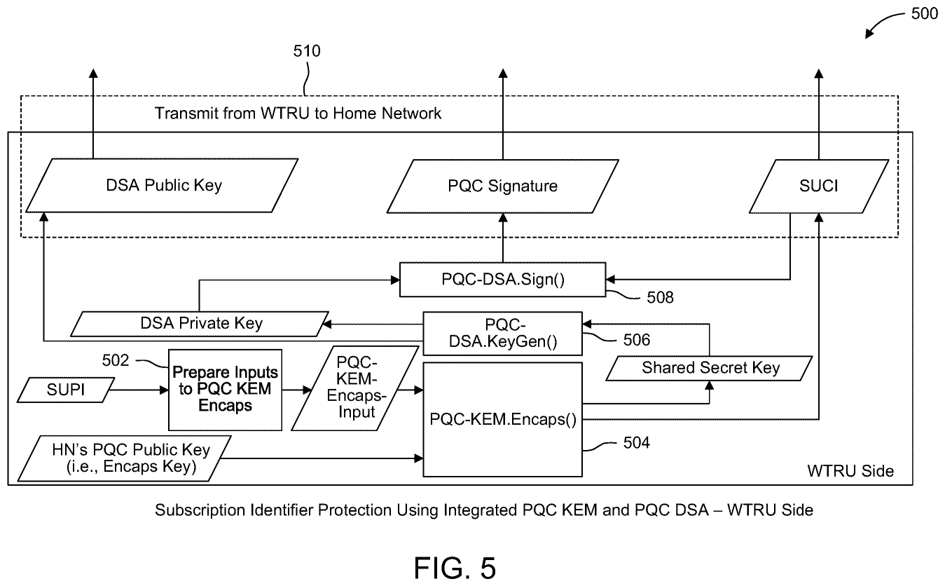

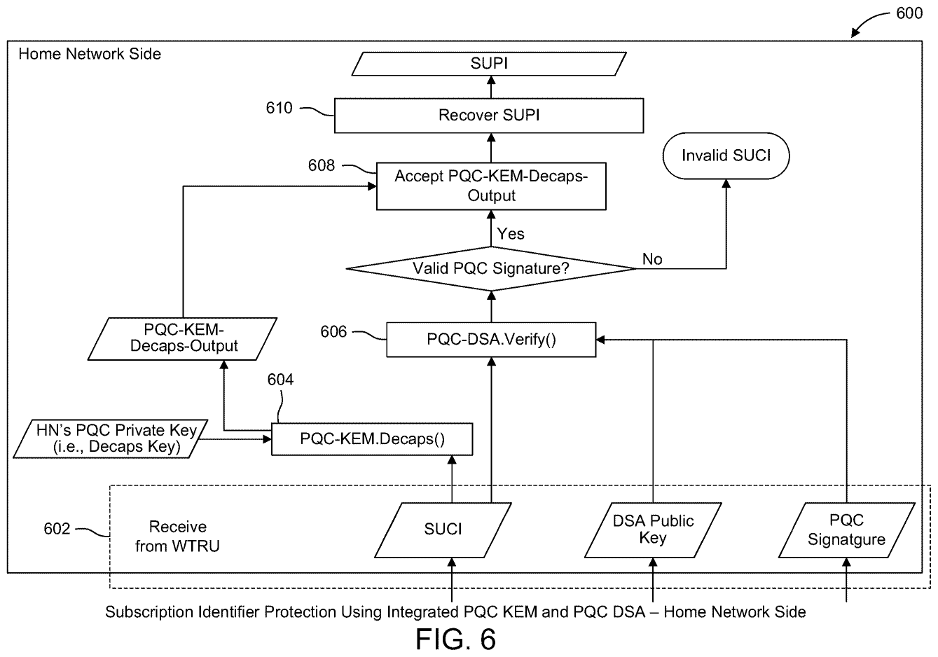

Embodiments for subscription identifier protection using integrated PQC KEM and PQC DSA are now described in reference to FIG. 5 and FIG. 6, where a PQC KEM algorithm and a PQC DSA algorithm are integrated. Specifically, the shared secret key generated by the PQC KEM algorithm may be used as the random seed for the PQC DSA algorithm to generate a DSA private key and a DSA public key.

Referring to FIG. 5 method 500 for a WTRU subscription identifier protection using integrated PQC KEM and PQC DSA is shown according to an example embodiment. In this embodiment, the PQC KEM algorithm may be used to encrypt the WTRU's SUPI (e.g., the MSIN part of a SUPI) and generate a SUCI (or a ciphertext). The PQC KEM algorithm may also generate a shared secret key, which may be used to derive a DSA private key based on the PQC DSA algorithm. Then, the PQC DSA algorithm is performed to sign the encrypted identifier using the DSA private key to generate a PQC Signature.

Some prerequisites for FIG. 5 method 500 may include the WTRU: (i) has obtained its SUPI; and (ii) has obtained or has been configured with a PQC public key of the home network (e.g., HN's PQC Public Key), which may have a larger size than the public key in classical asymmetric cryptography.

FIG. 5 method 500 may include, at 502, similar to FIG. 4 402, preparing the PQC-KEM Encaps input and performing the PQC-KEM.Encaps( ) function at 504, similar to FIG. 4 404 to generate the SUCI. In addition, a shared secret key may be generated by the PQC-KEM.Encaps( ) function. Using ML-KEM.Encaps( ) as an example, the size of the generated shared secret key is 32 bytes (for ML-KEM-512, ML-KEM-768, and ML-KEM-1024).

At 506, the WTRU may perform a PQC-DSA.KeyGen( ) function, which will use the shared secret key as the random seed and generate a DSA public key and a DSA private key as outputs. An example of PQC-DSA.KeyGen( ) is ML-DSA.KeyGen( ) as specified in FIPS 204. Using ML-DSA.KeyGen( ) as an example, the size of random seed should be 32 bytes. Thus, the generated shared secret key in 504 meets the size requirement of ML-DSA.KeyGen( ) on the size of the random seed. If the size of the shared secret key does not meet the size of random seed, a key derivation function may be used to first transform the shared secret key to a new shared secret key, which meets the size of random seed and will be fed to PQC-DSA.KeyGen( ).

At 508, similar to FIG. 4 406, the WTRU performs a PQC-DSA.Sign( ) which takes the DSA private key (generated in 504) and the SUCI as the input and generates a PQC Signature as the output. At 510, the WTRU may transmit the PQC Signature, the SUCI, the DSA Public Key to the home network, and the identifier or the name of used SUPIPPS (e.g., “Integrated PQC KEM and PQC DSA)”).

Referring to FIG. 6, a reciprocal method 600 for subscription identifier privacy protection using integrated PQC KEM and PQC DSA is shown according to an example embodiment. In this embodiment, at the home network side, the PQC KEM may first be used to decrypt the received SUCI to recover the SUPI of the WTRU. Then, the PQC DSA algorithm may also may be performed to verify the PQC Signature using the DSA pubic key.

A prerequisite for FIG. 6 method 600 may include the home network has maintained a PQC private key of the home network (e.g., HN's PQC Private Key), which may have a larger size than the private key in classical asymmetric cryptography.

FIG. 6 method 600 may include, at 602 the home network receives the PQC Signature, DSA Public Key, the SUCI from the WTRU, and the identifier or the name of used SUPIPPS. At 604, similar to FIG. 4 412, the PQC-KEM.Decaps( ) function (which may be specified by the identifier or the name of used SUPIPPS) is performed on the received SUCI using the home networks' PQC Private Key.

At 606, similar to FIG. 4 410, PQC-DSA.Verify( ) may take the DSA Public Key, the SUCI, and the PQC Signature as the input. The output of PQC-DSA.Verify( ) may indicate if the PQC Signature is valid or invalid. At 608, if the PQC Signature was verified as a valid one in 606, the WTRU may accept the PQC-KEM-Decaps-Output (generated in 604) and recover the SUPI at 610, similar to FIG. 4 414 as previously described. Steps 606 and 604 may be swapped.

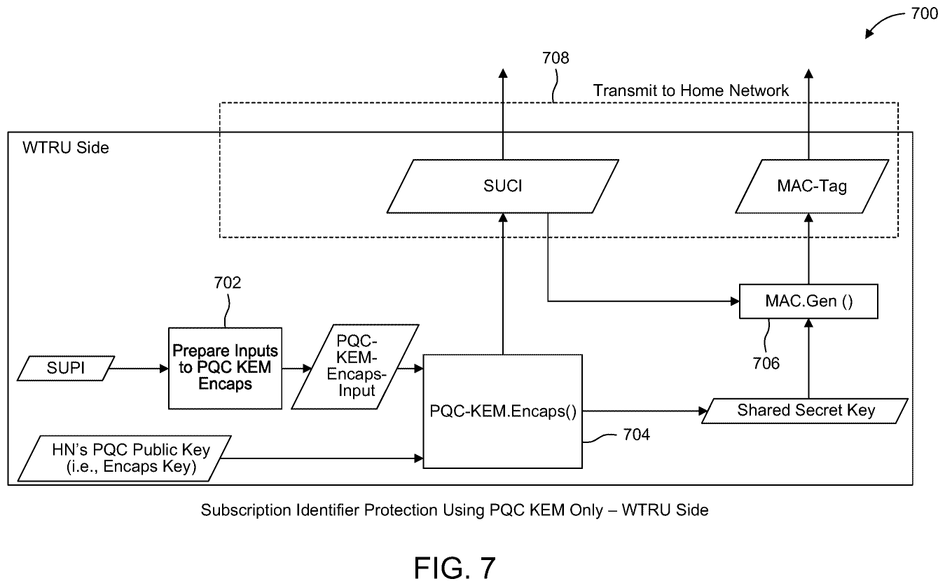

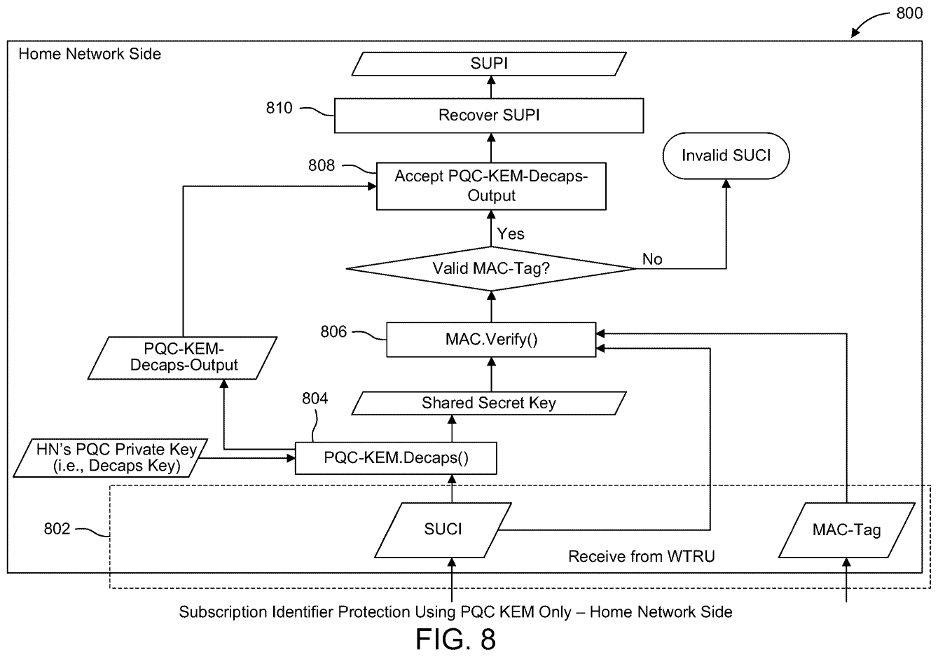

Embodiments for subscription identifier privacy protection using PQC KEM only are now described in reference to FIGS. 7 and 8, which respectively illustrate WTRU-side and network-side methods.

Referring to FIG. 7, a method 700 for encrypting the WTRU's SUPI using a PQC KEM algorithm may be used to encrypt the WTRU's SUPI (e.g., the MSIN part of a SUPI) and generating a SUCI (or a ciphertext) is shown according to an example embodiment. In an example the PQC KEM algorithm may also derive a shared secret key, which may be used to generate a Message Authentication Code (MAC) (i.e., MAC-Tag) or an authentication tag with respect to the SUCI. Both the SUCI and the MAC-Tag may be transmitted from the WTRU to the home network.

Some prerequisites for FIG. 7 method 700 may include the WTRU: (i): has obtained its SUPI; and (ii).has obtained or has been configured with a PQC public key of the home network (e.g., HN's PQC Public Key), which may have a larger size than the public key in classical asymmetric cryptography.

FIG. 7 method 700 may include at 702, similar to FIG. 4 402, the WTRU prepares inputs for the PQC-KEM-Encaps. The WTRU may perform a PQC-KEM.Encaps( ) function at 704, which may take the PQC-KEM-Encaps-Input and the HN's PQC Public Key as inputs and the PQC-KEM.Encaps( ) function may output a SUCI (or a ciphertext) and a shared secret key. As examples, the shared secret key may be a direct output of PQC-KEM.Encaps of 704 or a derived key based on the direct shared secret key from the PQC-KEM.Encaps( ) An example of the PQC-KEM.Encaps( ) function at 704 is a ML-KEM.Encaps( ) as specified in FIPS 203 module-lattice-based key-encapsulation, although the embodiments are not so limited.

At 706 The WTRU may perform a MAC.Gen( ) function to generate a MAC-Tag with respect to the SUCI. The inputs to MAC.Gen( ) at 706 may include the SUCI and the shared secret key. The output of MAC.Gen( ) of 706 is a MAC-Tag. In various embodiments, the MAC.Gen( ) function of 706 may be from a classical non-PQC algorithm (e.g., ECIES) or a PQC algorithm that uses a symmetric key for generating a MAC-Tag, a signature, an authentication tag, etc. Lastly, at 708, the WTRU may send the SUCI, the MAC-Tag to the home network, and the identifier or the name of used SUPIPPS (e.g., “PQC KEM Only”).

Referring to FIG. 8, a reciprocal method 800 is shown for a home network decryption based on the SUCI and MAC-Tag from the WTRU of FIG. 7. At the home network side, the PQC KEM algorithm may be used to recover the shared secret key. The shared secret key may be used to validate the MAC-Tag to ensure that the received SUCI is valid. The PQC KEM algorithm may also decrypt the SUCI to the SUPI.

A prerequisite for FIG. 8 method 800 may include the home network has maintained its PQC private key (i.e., HN's PQC Private Key), which may have a larger size than the private key in classical asymmetric cryptography.

FIG. 8 method 800 may include, at 802, the home network may receive the SUCI, the MAC-Tag, and the identifier or the name of the used SUPIPPS from the WTRU. At 804, the home network may perform a PQC-KEM.Decaps( ) function according to the identifier or the name of the used SUPIPPS. As examples, the inputs to PQC-KEM.Decaps( ) of 804 may include the HN's PQC Private Key and the received SUCI. The outputs of PQC-KEM.Decaps( ) of 804 may include a PQC-KEM-Decaps-Output, similar to FIG. 4 412. The output of PQC-KEM.Decaps( ) may also include a shared secret key, which should be the same as the shared secret key generated in FIG. 7 704. An example of PQC-KEM.Decaps( ) function is ML-KEM.Decaps( ) as specified in FIPS 203.

At 806, the home network may perform MAC.Verify( ) to verify if the received MAC-Tag is valid. The inputs to MAC.Verify( ) may include the received MAC-Tag, the received SUCI, and the shared secret key being generated, derived, decrypted, or decapsulated in 804. The output of MAC.Verify( ) indicates if the received MAC-Tag is valid or invalid.

In one example, MAC.Verify( ) may first generate a temporary MAC-Tag using the SUCI and the shared secret key. Then, MAC.Verify( ) may compare the temporary MAC-Tag with the received MAC-Tag. If both MAC-Tags are equal, the received MAC-Tag may be regarded as a valid one; otherwise, the received MAC-Tag may be regarded as an invalid one and an error message “Invalid SUCI or Invalid MAC-Tag” may be generated. This error message may be maintained by the home network and/or be sent to the WTRU. In examples, MAC.Verify( ) may be from a classical non-PQC algorithm (e.g., ECIES), or from a PQC algorithm that uses a symmetric key for validating a MAC-Tag, a signature, an authentication tag, etc.

At 808, if the received MAC-Tag is valid, the home network may accept the PQC-KEM-Decaps-Output and at 808. Similar to FIG. 4 414, the home network may recover the WTRU's SUPI from the PQC-KEM-Decaps-Output at 810.

Embodiments for hybrid subscription identifier protection based on PQC algorithms and traditional cryptographic algorithms are now described.

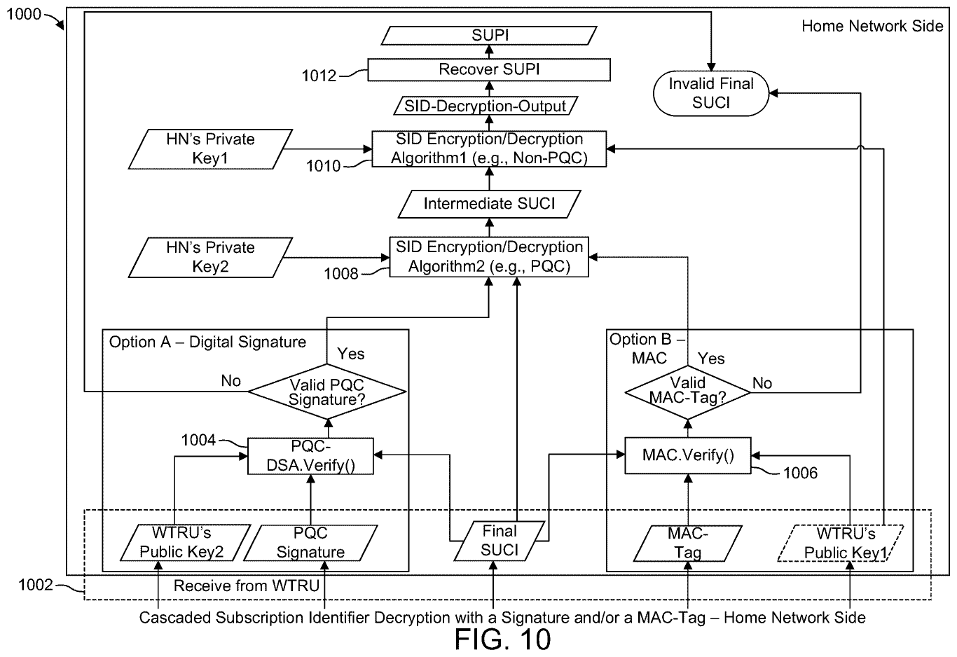

First embodiments for cascaded subscription identifier encryption with a signature and/or a MAC-Tag are described in reference to FIG. 9 and FIG. 10 for WTRU and network methods respectively. In these embodiments, methods of supporting SUPI privacy protection using a hybrid approach leverage both PQC algorithms and traditional cryptographic algorithms (i.e., non-PQC algorithms). These embodiments may provide a quantum-safe, secure and authorized way of transmitting a WTRU's SUPI from the WTRU to the home network. For these example embodiments, two sets of <WTRU's public key, WTRU's private key> may be used: one set for the PQC algorithm and the other set for the non-PQC algorithm. Similarly, two sets of <HN's public key, HN's private key> may be used: one set for the PQC algorithm and the other set for the non-PQC algorithm.

Referring to FIG. 9, a method 900 for WTRU supporting SUPI privacy protection using a hybrid approach leveraging both PQC algorithms and traditional cryptographic algorithms (i.e., Non-PQC algorithms) is shown according to an example embodiment. At the WTRU side, SID Encryption/Decryption Algorithm1 and Algorithm2 (e.g., a Non-PQC algorithm and a PQC algorithm) are used realize cascaded encryption of the WTRU's SUPI. Generally, the WTRU's SUPI is encrypted twice (either perform the PQC algorithm first or perform the non-PQC algorithm first) to generate the Final SUCI, which will be sent from the WTRU to the home network. This cascaded approach provides protection of subscription identifier against quantum attacks. Additionally, a PQC signature and/or MAC-Tag may be used to protect the integrity of the Final SUCI.

Prerequisites for FIG. 9 method 900 may include the WTRU: (i) has obtained its SUPI.; (ii) has generated two pairs of <WTRU's Public Key1, WTRU's Private Key1> and <WTRU's Public Key2, WTRU's Private Key2>. One pair of keys may be used by a non-PQC algorithm, while the other pair may be used by a PQC algorithm; and. (iii) has obtained or has been configured with two PQC public keys of the home network: one to be used by a non-PQC algorithm (e.g., SID Encryption/Decryption Algorithm1) and the other to be used by a PQC algorithm (e.g., SID Encryption/Decryption Algorithm2).

The FIG. 9 method 900 may include, at 902, similar to FIG. 4 402, the WTRU may append or concatenate additional information (e.g., Registration-Count, padding bytes, etc.) to the WTRU's SUPI. The WTRU may generate a SID-Encryption-Input.

At 904, the WTRU may perform SID Encryption/Decryption Algorithm1 (either a non-PQC algorithm or a PQC algorithm) to encrypt the SID-Encryption-Input from 902. As examples, the SID Encryption/Decryption Algorithm1 may be a non-PQC algorithm or a PQC algorithm.

If Algorithm1 is a non-PQC algorithm: (1) Algorithm2 in 906 will be a PQC algorithm. In this case, the inputs to Algorithm1 may include the SID-Encryption-Input, the HN's Public Key1, and the WTRU's Private Key1; and (2) The output of Algorithm1 may include an Intermediate SUCI (e.g., the encrypted version of the SID-Encryption-Input), an ephemeral MAC key, etc.

If Algorithm1 is a PQC algorithm: (1) Algorithm2 in 906 may be a non-PQC algorithm or another PQC algorithm. In examples, the inputs to Algorithm1 may include the SID-Encryption-Input and the HN's Public Key1; and (2) The output of Algorithm1 may include an Intermediate SUCI (e.g., the encrypted version of the SID-Encryption-Input), a shared secret key, etc.

At 906, the WTRU may perform SID Encryption/Decryption Algorithm2 (either a PQC algorithm or a non-PQC algorithm) to encrypt the Intermediate SUCI. In some examples, the Intermediate SUCI may be appended with some padding bytes to meet input requirements of SID Encryption/Decryption Algorithm2. For example, if SID Encryption/Decryption Algorithm1 is ECIES-based SUCI approach, the output Intermediate SUCI will be a 16-byte SUCI, which may need to be appended or concatenated with another 16 bytes to make it be 32 bytes, e.g., if SID Encryption/Decryption Algorithm2 is a ML-KEM-based approach that requires a 32-byte input message.

In an example, if Algorithm2 at 906 is a PQC algorithm, the inputs to Algorithm2 may include the Intermediate SUCI and the HN's Public Key2. The output of Algorithm2 at 906 may include a Final SUCI (e.g., the encrypted version of the “Intermediate SUCI”), a shared secret key, etc.

In another example, if Algorithm2 is a non-PQC algorithm, the inputs to Algorithm2 at 906 may include the Intermediate SUCI, the HN's Public Key2, and the WTRU's Private Key1. The output of Algorithm2 at 908 may include a Final SUCI (e.g., the encrypted version of the “Intermediate SUCI”), an ephemeral MAC key, etc.

In various embodiments, the integrity of the Final SUCI from 906 may be protected using a signature (Option A) at 908 and/or using a MAC-Tag (Option B) at 910.

For Option A in 908, the WTRU may perform a PQC digital signature algorithm (e.g., ML-DSA in FIPS 204) to sign the Final SUCI using the WTRU's Private Key2. As examples, the inputs to PQC-DSA.Sign( ) at 908 may include the Final SUCI and the WTRU's Private Key2. The output of PQC-DSA.Sign( ) at 908 may be a PQC Signature. 908 may be similar to FIG. 4 406 as previously discussed.

For Option B in 910, the WTRU may perform either a PQC MAC algorithm or a traditional non-PQC MAC algorithm to generate a MAC-Tag for the Final SUCI. As examples, the inputs to MAC.Gen( ) at 910 may include the Final SUCI, the shared secret key (for a PQC MAC algorithm) or the ephemeral MAC Key (for a non-PQC MAC algorithm such as ECIES-based SUCI as specified in 3GPP TS 33.501), etc.

The WTRU may execute 908 and/or 910. In an example of both Options A and B, 908 may be executed before or after 910.

At 912, the WTRU may transmit any or a combination of the following information (1)-(5) to the home network:
(1) WTRU's Public Key1: It is associated with the WTRU's Private Key1 used by a Non-PQC SID Encryption/Decryption (in either 904 or 906).
(2) WTRU's Public Key2: It is associated with the WTRU's Private Key2 used in 908 for generating the PQC Signature.
(3) PQC Signature: The digital signature generated in 908.
(4) Final SUCI: The encrypted version of the SUPI after performing SID Encryption/Decryption Algorithm1 and Algorithm2, respectively in 904 and 906.
(5) MAC-Tag: The MAC or authentication tag generated in 910 with respect to the Final SUCI.

96) Identifier of Used SUPIPPSs: the identifier or the name of used first SUPIPPS or SID Encryption Algorithm1 in 904, and the identifier or the name of used second SUPIPPS or SID Encryption Algorithm2 in 906.

Referring to FIG. 10, a reciprocal method 1000 is shown for the home network side using SID Decryption Algorithm1 and Algorithm2 (e.g., a PQC algorithm and a non-PQC algorithm) to realize cascaded decryption of the Final SUCI to recover the WTRU's SUPI. In this example, the home network may also verify the integrity of the received Final SUCI by validating the received PQC Signature (Option A) and/or the received MAC-Tag (Option B).

A prerequisite for FIG. 10 method 1000 may include the home network has generated two pairs of <HN's Public Key1, HN's Private Key1> and <HN's Public Key2, HN's Private Key2>. One pair of keys may be used by a non-PQC algorithm, while the other pair may be used by a PQC algorithm.

FIG. 10 method 1000 may include, at 1002, the home network may receive the following information from the WTRU: the WTRU's Public Key1, the WTRU's Public Key2, the PQC Signature, the Final SUCI, the MAC-Tag, the identifier or the name of used SUPIPPSs, etc.

Next, the home network may verify the integrity of the received Final SUCI by validating the received PQC Signature (either at 1004—Option A) and/or the received MAC-Tag (at 1006—Option B).

For Option A in 1004, the WTRU may perform a PQC digital signature algorithm (e.g., ML-DSA in FIPS 204) to verify the received PQC Signature using WTRU's Public Key2. In one example, the inputs to PQC-DSA.Verify( ) 1004 may include the received Final SUCI, the WTRU's Public Key2, and the received PQC Signature. The output of PQC-DSA.Verify( ) may be a Boolean indicating if the received PQC Signature is valid or invalid. 1004 may be similar to FIG. 4 410 as previously described.

For Option B in 1006, the WTRU may perform either a PQC MAC algorithm or a traditional non-PQC MAC algorithm to verify the received MAC-Tag. In an example, the inputs to MAC.Verify( ) 1006 may include the Final SUCI, the received MAC-Tag, the shared secret key (for a PQC MAC algorithm) or the ephemeral MAC Key (e.g., for a non-PQC MAC algorithm such as ECIES-based SUCI as specified in 3GPP TS 33.501), etc.

The home network may execute 1004 and/or 1006. In various example, 1004 may be performed before or after 1006, or in parallel if both Options A and B are utilized. If the received PQC Signature and/or the received MAC-Tag is valid, the home network may continue to execute 1008; otherwise, the home network may generate an error message such as “Invalid Final SUCI or Invalid PQC Signature or MAC-Tag” and other steps will not be performed.

At 1008, the home network may perform SID Encryption/Decryption Algorithm2 (e.g., a PQC algorithm or a non-PQC algorithm) to decrypt the received Final SUCI. As an example, the inputs to the Algorithm2 at 1008 may include the HN's Private Key2 and the received Final SUCI. The output of the Algorithm2 at 1008 may include the Intermediate SUCI.

At 1010, the home network may perform SID Encryption/Decryption Algorithm1 (e.g., a non-PQC algorithm or a PQC algorithm) to decrypt the Intermediate SUCI. If the Intermediate SUCI has some padding bytes, those padding bytes are removed before feeding the Intermediate SUCI to SID Encryption/Decryption Algorithm1. In an example, the inputs to the Algorithm1 at 1010 may include the HN's Private Key1 and the Intermediate SUCI generated by the Algorithm2. The output of the Algorithm1 at 1010 may include a SID-Decryption-Output, which should be the same as the SID-Encryption-Input in FIG. 9 method 900.

At 1012, similar to FIG. 4 414, the home network may remove context info and any padding bytes from the SID-Decryption-Output to recover the WTRU's SUPI.

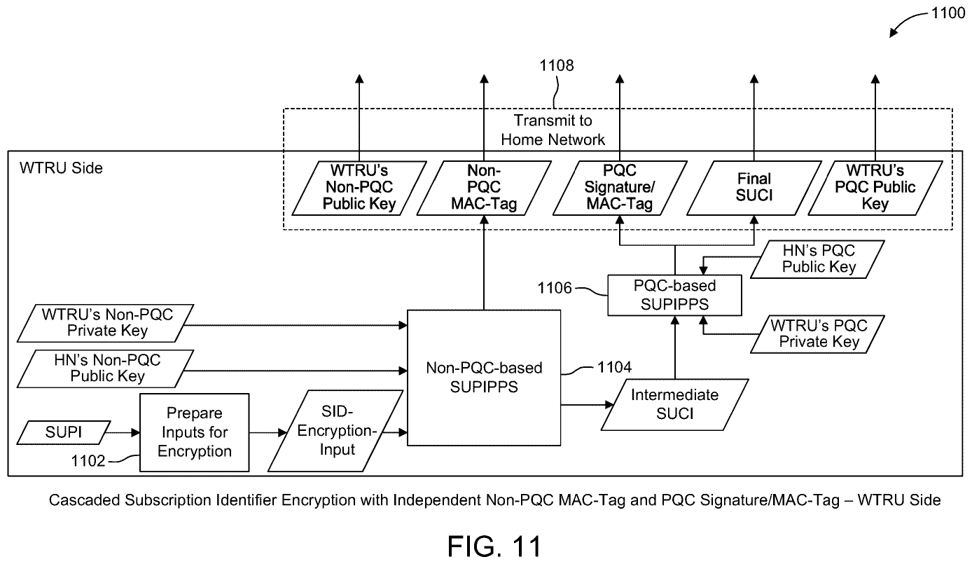

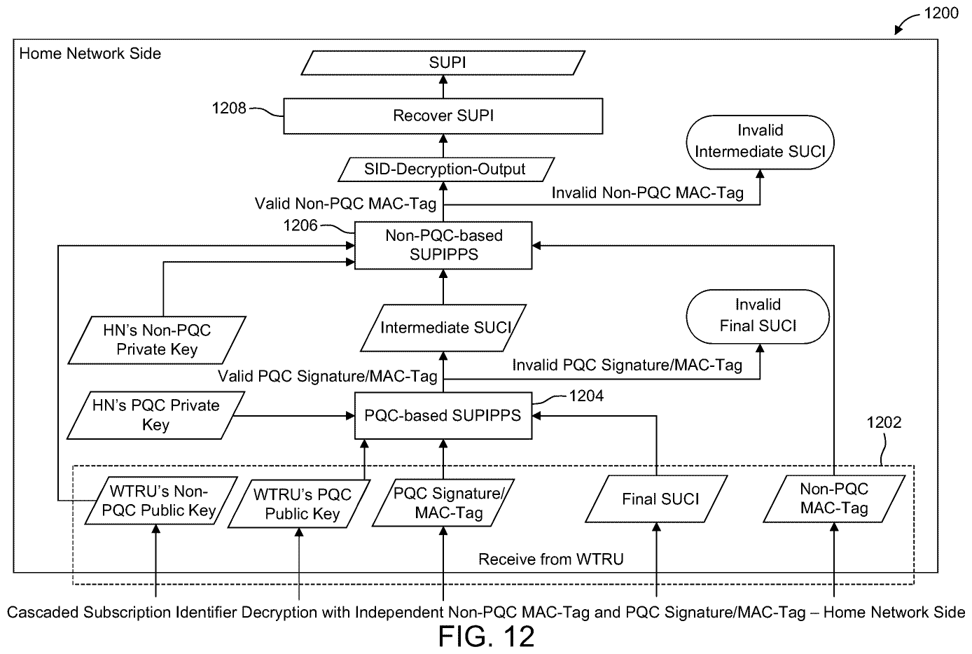

Embodiments for cascaded subscription identifier encryption with independent non-PQC MAC and PQC signature/MAC are disclosed in reference to FIG. 11 and FIG. 12 for WTRU and network methods respectively.

In this hybrid approach, both non-PQC-based SUPIPPS (e.g., ECIES-based SUCI approach in 3GPP TS 33.501) and PQC-based SUPIPPS (e.g., embodiments described previously) are used in a more independent way. As illustrated in the examples of FIG. 11 (WTRU) and FIG. 12 (NW), the non-PQC-based SUPIPPS generates an Intermediate SUCI and a non-PQC MAC-Tag that is used to protect the integrity of the Intermediate SUCI, while the PQC-based SUPIPPS generates a Final SUCI and a PQC Signature/MAC-Tag that is used to protect the integrity of the Final SUCI.

Referring to FIG. 11, a method 1100 for a WTRU performing cascaded subscription identifier encryption with independent non-PQC message authentication code (MAC)-Tag and PQC Signature/MAC-Tag is shown according to an example embodiment. Method 1100 for the WTRU may include basic steps of (i) performing cascaded subscription identifier encryption (e.g., using a non-PQC-based SUPIPPS to encrypt the SUPI and generate an Intermediate SUCI, and using a PQC-based SUPIPPS to encrypt the Intermediate SUCI to generate the Final SUCI); (ii) using a non-PQC-based SUPIPPS to generate a non-PQC MAC-Tag to protect the integrity of the Intermediate SUCI; and (iii) using a PQC-based SUPIPPS to generate a PQC Signature/MAC-Tag to protect the integrity of the Final SUCI. It is noted that the non-PQC MAC-Tag and the PQC Signature/MAC-Tag are independent of each other since they protect the integrity of different information. In another example, the WTRU may perform PQC-based SUPIPPS before the non-PQC-based SUPIPPS.

Some prerequisites for FIG. 11 method 11 may include the WTRU: (i) has obtained its SUPI; (ii) has generated one pair of <WTRU's Non-PQC Public Key, WTRU's Non-PQC Private Key>; (iii) has generated one pair of <WTRU's PQC Public Key, WTRU's PQC Private Key>; and (iv) has obtained or has been configured with two PQC public keys of the home network: 1) HN's Non-PQC Public Key to be used by the Non-PQC-based SUPIPPS; 2) HN's PQC Public Key to be used by the PQC-based SUPIPPS.

FIG. 11 method 1100 may include, at 1102, similar to FIG. 9 902, the WTRU prepares a SID-Encryption-Input based on the WTRU SUPI. At 1104, the WTRU may perform a non-PQC-based SUPIPPS (e.g., ECIES-based SUCI approach in 3GPP TS 33.501) to generate an Intermediate SUCI and a non-PQC MAC-Tag. As shown in FIG. 11, the inputs to the non-PQC-based SUPIPPS of 1104 may include: the WTRU's non-PQC Private Key (e.g., ephemeral private key in ECIES-based SUCI approach), the HN's Non-PQC Public Key (e.g., public key of HN in ECIES-based SUCI approach), and the SID-Encryption-Input from 1102.

At 1106, the WTRU may perform a PQC-based SUPIPPS (e.g., as described previously) to encrypt the Intermediate SUCI using HN's PQC Public Key. The Intermediate SUCI may be added with some padding bytes or other information to make it meet the size requirement of the input message to the PQC-based SUPIPPS. The output of the PQC-based SUPIPPS may include a PQC Signature or a PQC MAC-Tag (referred to as a PQC Signature/MAC-Tag) and a Final SUCI. The PQC Signature may be generated with respect to the Final SUCI using the WTRU's PQC Private Key, while the PQC MAC-Tag may be generated with respect to the Final SUCI using the shared secret key. The shared secret key may be generated as a part of this step by performing the PQC-based SUPIPPS.

At 1108, the WTRU may transmit a set of information to the home network, which may include: the WTRU's Non-PQC Public Key, the Non-PQC MAC-Tag, the PQC Signature or the PQC MAC-Tag, the Final SUCI, and the identifier or the name of used SUPIPPSs (i.e., the non-PQC-based SUPIPPS in 1104 and the PQC-based SUPIPPS in 1106). If the PQC Signature is transmitted from the WTRU to the home network, the WTRU also transmits the WTRU's PQC Public Key to the home network.

Referring to FIG. 12, a method 1200 for a home network performing cascaded subscription identifier decryption with independent non-PQC message authentication code (MAC)-Tag and PQC Signature/MAC-Tag is shown according to an example embodiment. The method for a home network may include basic steps of: (i) performing cascaded subscription identifier decryption (e.g., using a PQC-based SUPIPPS to decrypt the Final SUCI and generate the Intermediate SUCI, and using a non-PQC-based SUPIPPS to decrypt the Intermediate SUCI to generate the SUPI); (ii) using a PQC-based SUPIPPS to verify the PQC Signature/MAC-Tag; and (iii) using a non-PQC-based SUPIPPS to verify the non-PQC MAC-Tag. In other examples, the home network may perform the non-PQC-based SUPIPPS or SID protection scheme before the PQC-based SUPIPPS or SID protection scheme, if the WTRU-side (FIG. 11) has performed the PQC-based SUPIPPS before the non-PQC-based ID protection scheme.

A prerequisite for FIG. 12 method 1200 includes the home network has generated two pairs of keys: <HN's Non-PQC Public Key, HN's Non-PQC Private Key> and <HN's PQC Public Key, HN's PQC Private Key>.

FIG. 12 method 1200 may include, at 1202, the home network may receive the following information from the WTRU: the WTRU's Non-PQC Public Key, the PQC Signature & the WTRU's PQC Public Key or the PQC MAC-Tag, the Final SUCI, the Non-PQC MAC-Tag, the identifier or the name of used SUPIPPSs, etc. At 1204, the home network may perform the same PQC-based SUPIPPS as in FIG. 11 1106. The input to the PQC-based SUPIPPS at 1204 may include: the HN's PQC Private Key, the PQC Signature & the WTRU's Public Key (or the PQC MAC-Tag), and the Final SUCI.

The PQC-based SUPIPPS at 1204 may mainly performs two operations: (1) decrypt the Final SUCI to an Intermediate SUCI (e.g., leveraging the HN's PQC Private Key); and (2) verify the PQC Signature/MAC-Tag.

If the PQC Signature/MAC-Tag is valid, the PQC-based SUPIPPS outputs the Intermediate SUCI and the rest of steps will be continued. Otherwise, an error message “Invalid Final SUCI or Invalid PQC Signature/MAC-Tag” may be generated. This error message may be maintained by the home network and/or be sent to the WTRU.

At 1206, the home network may perform the same Non-PQC-based SUPIPPS as FIG. 11 1104. The input to the non-PQC-based SUPIPPS may include: the HN's Non-PQC Private Key, the WTRU's non-PQC Public Key, the non-PQC MAC-Tag, and the Intermediate SUCI. The Non-PQC-based SUPIPPS of 1206 may mainly perform two operations: (1) decrypt the Intermediate SUCI to a SID-Decryption-Output, which essentially may include the SUPI (e.g., leveraging the HN's Non-PQC Private Key); and (2) verify the non-PQC MAC-Tag.

If the non-PQC MAC-Tag is valid, the PQC-based SUPIPPS outputs a SID-Decryption-Output, which should be equal to the SID-Encryption-Input in FIG. 11. Otherwise, an error message “Invalid Intermediate SUCI or Invalid Non-PQC MAC-Tag” may be generated. This error message may be maintained by the home network and/or be sent to the WTRU. At 1208, the SUPI may be recovered from the SID-Decryption-Output, similar to 1012 in FIG. 10.

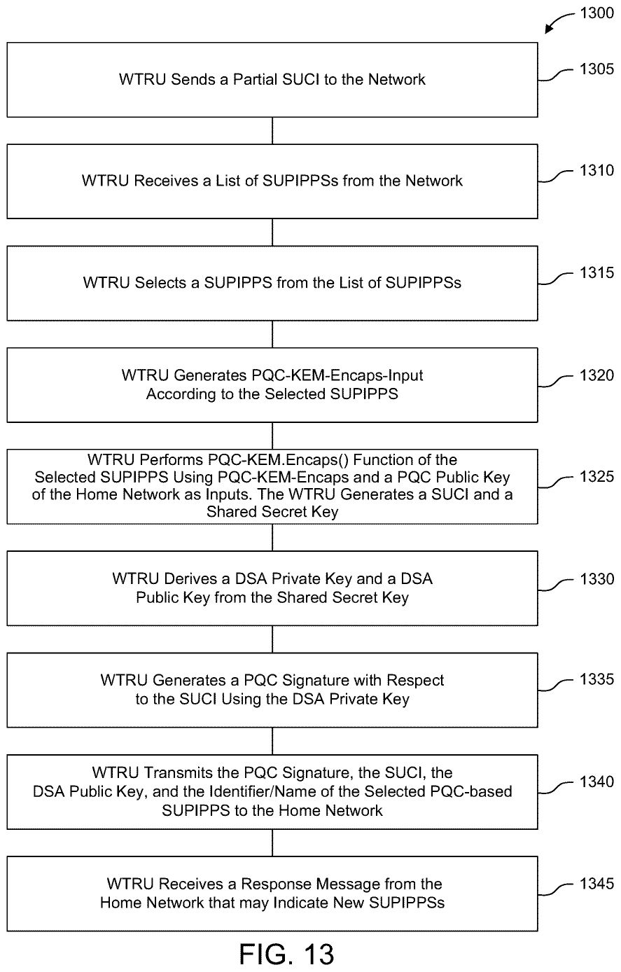

Referring to FIG. 13, a method 1300 is shown for a WTRU performing a PQC-based subscription identifier protection according to an example embodiment. In this embodiment, a WTRU may receive SUPI Privacy Protection Schemes (SUPIPPSs) from the home network. The WTRU may select a PQC-based SUPIPPS and may use the selected SUPIPPS to encrypt its SUPI to generate a SUCI. A PQC Signature or a MAC-Tag may be generated with respect to the SUCI. The WTRU may send the SUCI, the PQC Signature, or the MAC-Tag, and the identifier/name of the selected PQC-based SUPIPPS to the network.

FIG. 13 method 1300 may include the WTRU sending 1305 a first identifier, e.g., a partial SUCI, to the network and in response, receives 1310 a list of SUPIPPSs from the network. The WTRU selects 1315 a SUPIPPS from the list of SUPIPPSs and generates 1320 PQC-KEM-Encaps-Input according to the selected SUPIPPS. The WTRU performs 1325 a PQC-KEM.Encaps( ) function of the selected SUPIPPS using the PQC-KEM-Encaps-Input and a PQC public key of the home network as inputs and generates a second identifier, e.g., a SUCI, and a shared secret key.

The WTRU next derives 1330 a DSA Private Key and a DSA Public Key from the shared secret key and generates 1335 a PQC signature with respect to the SUCI using the DSA private key. At 1340, the WTRU transmits the PQC Signature, the SUCI, the DSA Public Key, and the identifier/name of the selected PQC-based SUPIPPS to the home network. In an example, the WTRU may then receive 1345 a response message from the home network that may indicate new SUPIPPSs.

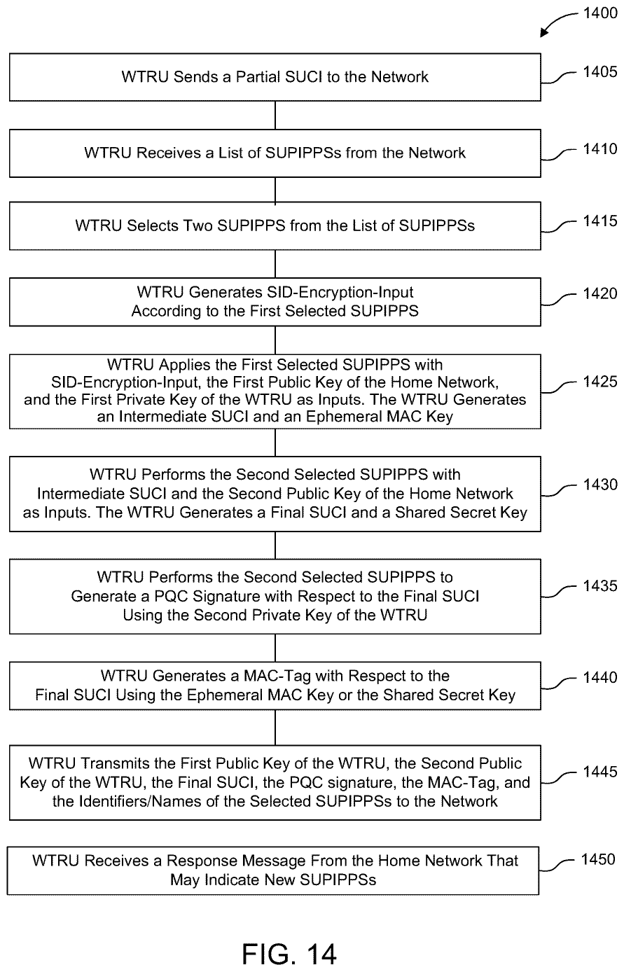

Referring to FIG. 14, a method 1400 for a WTRU performing a hybrid subscription identifier protection based on PQC and non-PQC algorithms is shown according to an example embodiment. In this embodiment, a WTRU may generally, receive at least two SUPI Privacy Protection Schemes (SUPIPPSs) or two SID encryption algorithms from the home network. The WTRU may select a PQC-based SUPIPPS or a PQC-based SID encryption algorithm and a non-PQC-based SUPIPPS or a non-PQC-based SID encryption algorithm. The WTRU may use the selected SUPIPPSs to encrypt its SUPI to generate a Final SUCI. A PQC Signature and a MAC-Tag may be generated with respect to the Final SUCI and the WTRU may send the Final SUCI, the PQC Signature, the MAC-Tag, the WTRU's PQC Public Key, the WTRU's Non-PQC Public Key, and the identifiers/names of the selected SUPIPPS to the home network.

In FIG. 14 method 1400 may include the WTRU sending 1405 a partial SUCI to the network and receiving 1410 a list of SUPIPPSs from the network. The WTRU selects 1415 two SUPIPPS from the list of SUPIPPSs, a first SUPIPPS, e.g., a non-PQC SUPIPPS, and a second SUPIPPS, e.g., a PQC SUPIPPS.

Next, the WTRU generates 1420 SID-Encryption-Input for the first selected SUPIPPS and applies 1425 the first selected SUPIPPS with the SID-Encryption-Input, the first public key of the home network, and the first private key of the WTRU as inputs, and outputs a generated Intermediate SUCI and an ephemeral MAC key.

The WTRU performs 1430 the second selected SUPIPPS with the Intermediate SUCI and the second public key of the home network as inputs and generates a Final SUCI and a shared secret key as outputs. The WTRU performs the second selected SUPIPPS to generate a PQC signature with respect to the Final SUCI using the second private key of the WTRU.

Next, the WTRU generates 1440 a MAC-Tag with respect to the Final SUCI using the ephemeral MAC key or the shared secret key. 1440 and 1430 may be swapped. At 1445, the WTRU transmits the first public key of the WTRU, the second public key of the WTRU, the Final SUCI, the PQC signature, the MAC-Tag, and the identifiers/names of the selected SUPIPPSs to the home network. In an example, the WTRU receives 1450 a response message from the home network that may indicate new SUPIPPSs

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by wireless transmit/receive unit (WTRU), the method comprising:
sending a first identifier to a network;
receiving, in response to sending the first identifier, a list of subscription permanent identifier privacy protection schemes (SUPIPPSs) from the network;
selecting a SUPIPPS from the list; and
encrypting, based on the selected SUPIPPS, a subscription permanent identifier (SUPI) of the WTRU in communicating with the network.

2. The method of claim 1, wherein the first identifier is a partial first subscription concealed identifier (SUCI).

3. The method of claim 1, wherein encrypting the SUPI comprises:
generating a post-quantum cryptography (PQC) key encapsulation input containing the SUPI, according to the selected SUPIPPS;
performing a PQC key encapsulation function of the selected SUPIPPS using the PQC key encapsulation input and a PQC public key of the network, to generate a second identifier and a shared secret key;
deriving a digital signature algorithm (DSA) private key and a DSA public key from the shared secret key; and
generating a PQC signature with respect to the second identifier using the DSA private key.

4. The method of claim 3, wherein the second identifier is a subscription concealed identifier (SUCI).

5. The method of claim 3, further comprising:
sending the PQC signature, the second identifier, the DSA public key and an identifier of the selected SUPIPPS to the network; and
receiving, from the network, a response message indicating a new SUPIPPS for future use.

6. The method of claim 1, wherein the encrypting based on selected SUPIPPS uses a PQC-key encapsulation mechanism (KEM).Encaps function.

7. A wireless transmit/receive unit (WTRU) comprising:
a transceiver; and
a processor communicatively coupled to the transceiver, wherein the transceiver and the processor are configured to:
send a first identifier to a network;
receive, in response to sending the first identifier, a list of subscription permanent identifier privacy protection schemes (SUPIPPSs) from the network;
select a SUPIPPS from the list; and
encrypt, based on the selected SUPIPPS, a subscription permanent identifier (SUPI) of the WTRU in communicating with the network.

8. The WTRU of claim 7, wherein the first identifier is a partial first subscription concealed identifier (SUCI).

9. The WTRU of claim 7, wherein in encrypting the SUPI, the processor is further configured to:
generate a post-quantum cryptography (PQC) key encapsulation input containing the SUPI, according to the selected SUPIPPS;
perform a PQC key encapsulation function of the selected SUPIPPS using the PQC key encapsulation input and a PQC public key of the network, to generate a second identifier and a shared secret key;
derive a digital signature algorithm (DSA) private key and a DSA public key from the shared secret key; and
generate a PQC signature with respect to the second identifier using the DSA private key.

10. The WTRU of claim 9, wherein the second identifier is a subscription concealed identifier (SUCI).

11. The WTRU of claim 9, further comprising:
sending the PQC signature, the second identifier, the DSA public key and an identifier of the selected SUPIPPS to the network; and
receiving, from the network, a response message indicating a new SUPIPPS for future use.

12. The WTRU of claim 7, wherein the encrypting based on the selected SUPIPPS uses a PQC-key encapsulation mechanism (KEM).Encaps function.

13. A method for a wireless transmit/receive unit (WTRU), the method comprising:
sending a first identifier to a network;
receiving, in response to sending the first identifier, a list of subscription permanent identifier privacy protection schemes (SUPIPPSs) from the network;
selecting from the list, a first SUPIPPS and a second SUPIPPS;
performing first subscriber identification (SID) encryption relating to a subscription permanent identifier (SUPI) of the WTRU, based on a first algorithm of the selected first SUPIPPS; and
performing second SID encryption relating to the SUPI of the WTRU based on a second algorithm of the selected second SUPIPPS; and
sending, to the network, a subscriber concealed identity (SUCI) based on the first and second SID encryptions.

14. The method of claim 13, wherein performing the first SID encryption comprises:
generating a SID encryption input containing the SUPI according to the selected first SUPIPPS; and
generating an intermediate SUCI and an ephemeral message authentication code (MAC) key based on the first algorithm using the SID encryption input, a first public key of the network and a first private key of the WTRU as inputs.

15. The method of claim 14, wherein performing the second SID encryption comprises
generating a final SUCI and a shared secret key using the second algorithm with the intermediate SUCI and a second public key of the network as inputs; and
at least one of,
(i) performing the selected second SUPIPPS to generate a post-quantum cryptography (PQC) signature with respect to the final SUCI using a second private key of the WTRU; and/or
(ii) generating a MAC-tag with respect to the final SUCI using the ephemeral MAC key or the shared secret key.

16. The method of claim 15, wherein sending, to the network, a subscription concealed identifier (SUCI) based on the first and second SID encryptions comprises:
sending, to the network, the first public key of the WTRU, the second public key of the WTRU, the final SUCI, identifiers of the selected first SUPIPPS and second SUPIPPS; and at least one of the PQC signature and/or the MAC-tag.

17. The method of claim 13, further comprising:
receiving, from the network, a response message indicating a new SUPIPPS for future use.
